(19) United States
(12) Patent Application Publication
(10) Pub. No.: US 2024/0067801 A1
(43) Pub. Date: Feb. 29, 2024

(54) COMPOSITION FOR USE AS A COATING

(71) Applicant: OrganoGraph AB, Sundsvall (SE)

(72) Inventors: Armando CORDOVA, Stockholm (SE); Rana ALIMOHAMMADZADEH, Sundsvall (SE)

(73) Assignee: OrganoGraph AB, Sundsvall (SE)

(21) Appl. No.: 18/259,218

(22) PCT Filed: Dec. 21, 2021
(86) PCT No.: PCT/EP2021/087037

§ 371 Date: Jun. 23, 2023

(30) Foreign Application Priority Data
Dec. 23, 2020 (SE) 2051555-7
Oct. 6, 2021 (SE) 2151224-9
Oct. 8, 2021 (SE) 2151231-4

(51) Int. Cl. C08K 5/41; C09D 5/16; C09D 5/18; C09D 7/63; C09D 183/04

(52) U.S. Cl. CPC C08K 5/41; C09D 5/1675; C09D 5/18; C09D 7/63; C09D 183/04; C08K 3/36

(57) ABSTRACT

The present invention relates to a composition comprising a polymerized C₁₀₋₃₀alkanetriC₁₋₅alkoxysilane, a surfactant, an organic acid catalyst and water, and optionally an inorganic component and to a process for manufacturing said composition. The invention also relates to uses of the composition as a water repellant coating, and/or as a mold-resistant coating and/or as a fire-resistant coating on organic or inorganic surfaces.

### FIELD OF THE INVENTION

The present invention relates to a composition comprising a polymerized C₁₀₋₃₀ alkanetriC₁₋₅alkoxysilane, a surfactant, an organic acid catalyst and water, and optionally an inorganic component and to a process for manufacturing said composition. The invention also relates to uses of the composition as a water repellant coating, and/or as a mold-resistant coating and/or as a fire-resistant coating on organic or inorganic surfaces.

### BACKGROUND OF THE INVENTION AND PRIOR ART

Coating is applying a layer or film on a surface of an object, such as metal, plastic or wood. The layer, film or coating may be functionalized by creating specific properties or functions on the coating. The coating may for example be made electronic conducting or hydrophobic, lipophobic or have optical properties.

A lot of research has been performed on the development of hydrophobic surfaces, especially for use on fabrics to make the fabrics hydrophobic. Other research has been directed to fire resistance coatings and coatings having anti-microbial properties. Many of these coatings, however, contain poly-fluoro-alkanes, e.g. PFAS. These fluoro-alkanes may cause severe damage to humans and nature.

Transparency of a coating is important for coating optical object and glasses. Transparency of a coating may also be important for aesthetic appearances.

Roughness of a coating may be important to prevent slipping and scratching of a surface. Evenness of a rough coating is important for the mechanical and chemical stability of the coating as well as for the aesthetic appearance of a coating.

Combining roughness with transparency is challenging. Inorganic components may be added to the composition to provide a roughness. However, transparency requires the surface roughness to be less than 100 nm (i.e. less than a quarter of the wavelength of visible light) to prevent the coating from becoming opaque or less transparent.

Thermal, chemical, and mechanical stability of a coating ensures durability and are important measures for the quality of a coating. Degradation products of a coating must be environmentally stable.

Coatings may be manufactured using different processes. For large scale production and scalability, the process time is preferably short and without use of high temperatures and high pressure. In most known processes, solvents are used, such as alcohols, ammonia, ammonium hydroxide, sulfonates, amides. Many such solvents are volatile, flammable, corrosive and harmful to humans and nature. For large scale production, such solvents are preferably avoided.

Applying the coating on a surface should preferably be done in a simple and inexpensive manner.

CN106883646A discloses a graphene-based coating dispersion having good water repellency comprising fluorosilicon monomers (trifluoropropylmethylcyclotrisiloxane, tridecafluorooctane trimethoxysilane, tridecafluorooctyltriethoxysilane, heptafluorodecyltrimethoxysilane), ceramic oxides (silicon dioxide, titanium dioxide), nano graphene oxide and water. As mentioned above, the use of fluoro-comprising compounds should be prevented for environmentally reasons.

CN106800885A discloses a transparent super-hydrophobic/super-amphiphobic coating on wood comprising fluorine-free organosilane (dodecyltrimethoxysilane, dodecyltriethoxysilane, hexadecyltrimethoxysilane, hexadecane triethoxysilane), nanoparticles (silicon dioxide, titanium dioxide), catalyst (oxalic acid) and alcohol-water mixed system. The nanoparticles are at least one of montmorillonite, lithium saponite, attapulgite, hydrotalcite, kaolinite, silica, titania, zinc oxide, aluminum oxide, carbon nanotubes, graphene or nanofibers One. The particle size of the nanoparticles is 5 to 60 nm. The manufacturing process for this complex coating takes days using high temperatures and high pressures.

XU, L., Wang, L., Shen, Y. et al. Preparation of hexadecyltrimethoxysilane-modified silica nanocomposite hydrosol and superhydrophobic cotton coating. Fibers Polyrn 16, 1082-1091 (2015). https://doi.org/10.1007/s12221-015-1082-x, discloses a process for preparation of H—SiO₂ nanocomposite hydrosol coating for cotton fabric to provide superhydrophobicity comprising precursor silica nanoparticles, methyltrimethoxysilane, hexadecyltrimethoxysilane, surfactant sodium dodecyl benzenesulfonate, base catalyst ammonium hydroxide, water. The manufacturing of silane-modified silica is complex and expensive. Use of the solvents mentioned should be avoided for environmentally reasons.

WO2008098069A1 discloses composition for use in a multilayer coating comprising an outer surface of hydrophobic silica nanoparticles. The particles have hydrophobic surface coatings comprising octadecyltrimethoxysilane (OTMS), triethoxy(octyl)silane (OTES), or 1H,1H,2H,2H-perfluorooctyltriethoxysilane (POTS). Different types of nanoparticles are mentioned, such as TiO₂, carbon black, silica, carbon nanotubes, inorganic and organic nanomaterials, and naturally occurring nanomaterials. An active ingredient that is fire retardant or fire suppressant can be added to the composition if the coating is to be used as a fire-resistance coating. The manufacturing of surface modified silica is complex and expensive. A coating having different layers within the coating is complex, less stable over time and expensive to manufacture.

CN107029479A discloses a high-temperature resistant and long-lasting dust-removing cloth bag material comprising 5 parts of gamma-methacryloxypropyltrimethoxysilane, 7.5 parts of nano titanium dioxide, 1.2 parts of citric acid. Use of this complex and environmentally unfriendly coating is complex and expensive. The application of the coating is restricted to fabrics.

CN108517154A discloses a water-based, fluorine-free super-hydrophobic nanocomposite coating used for coating on a surface of wood, polymer substrate or paper material comprising 1 to 20 percent of low-surface-energy coupling agent (octadecyl triethoxy alkyl, hexadecyl trimethoxy silane, hexadecyl triethoxy silane, dodecyl trimethoxy silane, dodecyl triethoxy silane), 2 to 30 percent of nano-silica or nano-titania nanoparticles and 30 to 90 percent of water. Solvents, such ethanol, acrylic and vinylic compounds are used in the composition. Applying the coating requires 24 hours of drying at 60° C.

WO2011086012 discloses a method of making a cellulosic water-repellent material and cellulosic material made water-repellent by such method. The method comprises; providing a solution of an acid of pKa 2-C4 alcohol optionally comprising water; providing an alkyltrialkoxyosilane; efficiently mixing the solution and the alkyltrialkoxysilane to produce a silanization composition; contacting the cellulosic material with the silanization composition; curing the cellulosic material at a temperature of 100° C. or more until substantially dry; optionally rinsing the treated material with an liquid media to remove the acid and optionally drying the rinsed treated material. The cellulosic water-repellent material is for example a cellulosic textile material. The manufacturing method of this modified silanized cellulose is complex and expensive.

WO2014/139931 discloses a method and composition for obtaining a water-repellent and/or water-soluble dirt repellent textile. The composition consists of water, C₁₀₋₃₀-alkylalkoxysilane, at least one emulsifier, surfactant (alkyl hydrogen sulfates), thickener and/or stabilizer, a water-soluble acid catalyst and unavoidable impurities.

The method comprises the steps of applying the composition on the textile, drying the treated textile until dry, curing the treated textile at a temperature of between 100-200° C., and optionally removing the non-reacted composition residue from the treated textile by washing with water and optionally redrying the treated textile. Amino silicones may be added for softness and durability. This composition is rather complex, expensive, time consuming and costly to apply and does not provide a rough surface of the coating.

WO2017089413 discloses a process for the preparation of nanocellulose and derivatives thereof, comprising reacting nanocellulose with one or more silanes preferably in the presence of an organic catalyst. The silane is of formula 2,2-dimethoxy-2-phenylacetophenone (DMPA), and—thiol compound, olefin compound or alkyne compound, wherein the reaction is carried out in the presence of UV-light or heat. Use for the composition as as water repellant is mentioned. The manufacturing of modified silanized cellulose is complex and expensive.

Zhao Q. et al., 2016, vol. 92, pages 541-545, Materials Science, Materials & Design, D01:10.1016/J.MATDES.2015.12.054, Corpus ID: 137970947, Ambient-curable superhydrophobic fabric coating prepared by water-based non-fluorinated formulation, discloses a process for preparing superhydrophobic coatings for polyester, cotton and mixed cotton/polyester comprising 0.15 g of LE2 silica nanoparticles, 0.5 g HDTMS, 4 g of APTES, 36 g of distilled water. The manufacturing of modified silanized silica is complex and expensive.

### SUMMARY OF THE INVENTION

It is an object of the present invention to at least partly overcome the above-mentioned problems, and to provide an improved composition for use as a water-, microbial-, molt- and fire-resistant coating.

This object is achieved by a composition as defined in the claims.

According to an aspect of the invention, the composition comprises or consists of
3 to 15 wt % of a polymerized C10-30alkanetriC₁₋₅alkoxysilane,
0.3 to 1.5 wt % of a surfactant,
0.04 to 0.40 wt % of an organic acid catalyst,
optionally 0.5 to 10 wt % of an inorganic component selected from the group comprising or consisting of silica dioxide gel, pyrogenic silica, crystalline silica, titanium dioxide, nanographite, nanographene and water glass (WGSi), and
up to 100 wt % water, wherein weight percentages are percentages of the total weight of the composition. In some aspects, the surfactant is sodium dodecyl sulfate. In some aspects, the organic acid catalyst is selected from the group comprising or consisting of tartaric acid, citric acid, oxalic acid, fumaric acid, maleic acid and lactic acid. In some aspects, the polymerized alkanetrialkoxysilane is hexadecyltrimethoxysilane or octadecyltrimethoxysilane.

According to an aspect of the invention, the composition comprises or consists of
4 to 15 wt % of a polymerized C10-30alkanetriC₁₋₅alkoxysilane,
0.4 to 1.2 wt % of a surfactant,
0.04 to 0.30 wt % of an organic acid catalyst,
0.5 to 10 wt % of an inorganic component selected from the group comprising or consisting of silica dioxide gel, pyrogenic silica, crystalline silica, titanium dioxide, nanographite, nanographene and water glass (WGSi), and
up to 100 wt % water, wherein weight percentages are percentages of the total weight of the composition. In some aspects, the surfactant is sodium dodecyl sulfate. In some aspects, the organic acid catalyst is selected from the group comprising or consisting of tartaric acid, citric acid, oxalic acid, fumaric acid, maleic acid and lactic acid. In some aspects, the polymerized alkanetrialkoxysilane is hexadecyltrimethoxysilane or octadecyltrimethoxysilane.

In some aspects, the composition comprises or consists of
4 to 13 wt % of a polymerized C₁₄₋₂₀ alkanetrimethoxyalkoxysilane,
0.5 to 1.1 wt % of a surfactant,
0.04 to 0.30 wt % of an organic acid catalyst,
optionally 1 to 5 wt % of an inorganic component selected from the group comprising or consisting of silica dioxide gel, pyrogenic silica, crystalline silica, titanium dioxide, nanographite, nanographene and water glass (WGSi), and
up to 100 wt % water, wherein weight percentages are percentages of the total weight of the composition. In some aspects, the surfactant is sodium dodecyl sulfate. In some aspects, the organic acid catalyst is selected from the group comprising or consisting of tartaric acid, citric acid, oxalic acid, fumaric acid, maleic acid and lactic acid. In some aspects, the polymerized alkanetrialkoxysilane is hexadecyltrimethoxysilane or octadecyltrimethoxysilane.

According to an aspect of the invention, the composition comprises or consists of
4 to 10 wt % of a polymerized C10-30alkanetriC₁₋₅alkoxysilane,
0.6 to 0.9 wt % of a surfactant,
0.04 to 0.15 wt % of an organic acid catalyst,
0.5 to 10 wt % of an inorganic component selected from the group comprising or consisting of silica dioxide gel, pyrogenic silica, crystalline silica, titanium dioxide, nanographite, nanographene and water glass (WGSi), and
up to 100 wt % water, wherein weight percentages are percentages of the total weight of the composition. In some aspects, the organic acid catalyst is selected from the group comprising or consisting of tartaric acid, citric acid, oxalic acid, fumaric acid, maleic acid and lactic acid. In some aspects, the polymerized alkanetrialkoxysilane is hexadecyltrimethoxysilane or octadecyltrimethoxysilane.

According to an aspect of the invention, the composition comprises or consists of
4 to 13 wt %, or 4 to 5 wt % of a polymerized C₁₀₋₃₀alkanetriC₁₋₅alkoxysilane,
0.5 to 1.2 wt %, or 0.6 to 0.9 wt % of a surfactant,
0.05 to 0.15 wt %, or 0.04 to 0.08 wt % of an organic acid catalyst,
optionally 1 to 7 wt % of an inorganic component selected from the group comprising or consisting of silica dioxide gel, pyrogenic silica, crystalline silica, titanium dioxide, nanographite, nanographene and water glass (WGSi), and
up to 100 wt % water, wherein weight percentages are percentages of the total weight of the composition. In some aspects, the surfactant is sodium dodecyl sulfate. In some aspects, the organic acid catalyst is selected from the group comprising or consisting of tartaric acid, citric acid, oxalic acid, fumaric acid, maleic acid and lactic acid. In some aspects, the polymerized alkanetrialkoxysilane is hexadecyltrimethoxysilane or octadecyltrimethoxysilane.

In some aspects, the composition comprises or consists of
4 to 10 wt %, or 4 to 5 wt % of polymerized C₁₄₋₂₄alkanetrimethoxysilane,
0.6 to 0.9 wt % of surfactant, which is sodium dodecyl sulfate,
0.05 to 0.15 wt %, or 0.04 to 0.08 wt % of an organic acid catalyst selected from the group comprising or consisting of tartaric acid, citric acid, oxalic acid, fumaric acid, maleic acid and lactic acid,
2 to 5.5% of an inorganic component selected from the group comprising or consisting of silica dioxide gel, pyrogenic silica, crystalline silica, titanium dioxide, nanographite and water glass (WGSi), and
up to 100 wt % water, wherein weight percentages are percentages of the total weight of the composition. In some aspects, the polymerized alkanetrialkoxysilane is hexadecyltrimethoxysilane or octadecyltrimethoxysilane.

In some aspects, the composition comprises or consists of
4 to 10 wt %, or 4.5 to 5 wt % of polymerized C₁₄₋₂₀alkanetrimethoxysilane,
0.7 to 0.85 wt % of surfactant, which is sodium dodecyl sulfate,
0.045 to 0.145 wt %, or 0.045 to 0.07 wt % of an organic acid catalyst selected from the group comprising or consisting of tartaric acid, citric acid and oxalic acid, or tartaric acid, citric acid, oxalic acid, fumaric acid, maleic acid and lactic acid,
2 to 3 wt % or 4 to 5 wt % of an inorganic component selected from the group comprising or consisting of silica dioxide gel, pyrogenic silica, crystalline silica, titanium dioxide, nanographite and water glass (WGSi), and
up to 100 wt % water, wherein weight percentages are percentages of the total weight of the composition. In some aspects, the polymerized alkanetrialkoxysilane is hexadecyltrimethoxysilane or octadecyltrimethoxysilane.

In some aspects, the inorganic component is silica dioxide gel.

In some aspects, the inorganic component is pyrogenic silica.

In some aspects, the inorganic component is nanographite.

In some aspects, the inorganic component is crystalline silica,

In some aspects, the inorganic component is water glass (WGSi).

In some aspects, the inorganic component is titanium dioxide.

The inorganic component provides roughness to the coating. Especially water glass provides for a fire-resistant coating.

The composition as defined above is hydrophobic and has a contact angle above 130°, or above 140°, or above 150°. Although the inorganic component has a relatively high surface energy, it is used in low amounts of 0.5 to 10 wt % or 0.5 to 5.5 wt %. The polymerized silane, which has a low surface energy, in the amounts of 2 to 15 wt %, or 4 to 13 wt %, or 4 to 5 wt % or 4.5 to 5 wt % compensates for the high surface energy of the inorganic compound.

The composition is transparent, white or black, while having a roughness because the roughness provided by the 0.5 to 10 wt % or 0.5 to 5.5 wt %, or from 1 to 3 wt % or 4 to 5 wt %.

inorganic component is less than a quarter of the wavelength of visible light (100 nm).

It has also been found that a composition that does not comprise or contain the inorganic component has the same excellent effects as a composition that does comprise or contain the inorganic component. When the composition does not comprise or contain the inorganic component the concentration of the polymerized alkanetrialkoxysilane is preferably over>8% wt. This percentage of the polymerized alkanetrialkoxysilane compound will provide a coating having the roughness and contact angle (e.g. >120 or >130) needed.

In some aspects, the composition comprises or consists of
5 to 15 wt %, or 6 to 12.5 wt % of a polymerized C₁₀₋₃₀alkanetriC₁₋₅alkoxysilane,
0.4 to 1.2 wt %, or 0.5 or 1.0 wt % of a surfactant,
0.04 to 0.5 wt %, or 0.05 to 0.3 wt % of an organic acid catalyst, and
up to 100 wt % water, wherein weight percentages are percentages of the total weight of the composition. In some aspects, the surfactant is sodium dodecyl sulfate. In some aspects, the organic acid catalyst is selected from the group comprising or consisting of tartaric acid, citric acid, oxalic acid, fumaric acid, maleic acid and lactic acid. In some aspects, the organic acid catalyst is selected from the group comprising or consisting of tartaric acid, citric acid, fumaric acid, maleic acid and lactic acid. In some aspects, the polymerized alkanetrialkoxysilane is hexadecyltrimethoxysilane or octadecyltrimethoxysilane.

In some aspects, the composition comprises or consists of
5 to 15 wt %, or 6 to 12.5 wt % of polymerized C₁₄₋₂₄alkanetrimethoxysilane,
0.5 to 1.2 wt %, or 0.5 or 1.0 wt % of surfactant, which is sodium dodecyl sulfate,
0.04 to 0.5 wt %, or 0.05 to 0.3 wt % of an organic acid catalyst selected from the group comprising or consisting of tartaric acid, citric acid, oxalic acid, fumaric acid, maleic acid and lactic acid, and
up to 100 wt % water, wherein weight percentages are percentages of the total weight of the composition. In some aspects, the polymerized alkanetrialkoxysilane is hexadecyltrimethoxysilane or octadecyltrimethoxysilane.

In some aspects, the composition comprises or consists of
5 to 15 wt %, or 6 to 12.5 wt % of polymerized C₁₄₋₂₀alkanetrimethoxysilane,
0.5 to 1.2 wt %, or 0.5 or 1.0 wt % of surfactant, which is sodium dodecyl sulfate,
0.04 to 0.5 wt %, or 0.05 to 0.3 wt % of an organic acid catalyst selected from the group comprising or consisting of tartaric acid, citric acid and oxalic acid, or tartaric acid, citric acid, fumaric acid, maleic acid and lactic acid, and
up to 100 wt % water, wherein weight percentages are percentages of the total weight of the composition. In some aspects, the polymerized alkanetrialkoxysilane is hexadecyltrimethoxysilane or octadecyltrimethoxysilane.

The surfactant is used as a binder and provides for a homogeneous composition having an evenly distributed roughness of the composition, when used as a coating. The surfactant is believed to improve hardening of the composition upon application and thus reduces the drying time, which saves costs. The combination of the surfactant, such as sodium dodecyl sulfate and the inorganic component provides for the fire-resistant coating. Especially, the combination of sodium dodecyl sulfate and water glass provides for a fire-resistant coating.

The of the organic acid catalyst improves hardening of the coating after application. The presence of the catalyst reduces time needed for drying of the coating and thus reduces time and cost for applying the coating.

The combination of both surfactant and catalyst are believed to provide an improved chemical and mechanical stability to a coating made of the composition.

The composition comprises environmentally friendly ingredients and is biocompatible. Only water is used as a solvent.

The composition is chemically, thermally, and mechanically stable.

All ingredients can be readily provided in large quantities, which allows for scalability in a cost-effective manner.

In some aspects, graphene as ingredient is disclaimed. In some aspects, cellulose as ingredient is disclaimed. In some aspects, surface modified silica as ingredient is disclaimed. In some aspects, silanized silica as ingredient is disclaimed. In some aspects, the inorganic component is silicon is disclaimed. In some aspects, the inorganic component is pyrogenic silica, is disclaimed. In some aspects, the inorganic component is crystalline silica, is disclaimed. In some aspects, silanized cellulose as ingredient is disclaimed. In some aspects, sulfonate as ingredient is disclaimed. In some aspects, ammonium as ingredient is disclaimed.

The invention also relates to a process for the manufacturing of the composition defined anywhere herein comprising or consisting of the step of
a) providing the solution of 0.5 to 1.5 wt % or 0.6 to 0.9 wt % of surfactant and 0.04 to 0.5 wt %, or 0.05 to 0.3 wt %, or 0.04 to 0.08 wt % of an organic acid catalyst,
b) adding 5 to 15 wt %, or 6 to 12.5 wt %, or 2 to 5 wt %, or 4 to 5 wt % of C₁₀₋₃₀ alkanetriC₁₋₅alkoxysilane until polymerized and homogenized
c) optionally, providing 0.5 to 10% wt or 2 to 5% wt solution of the inorganic component,
d) optionally adding the solution of the inorganic component to the polymerized C₁₀₋₃₀alkanetriC₁₋₅alkoxysilane, and
e) homogenizing the obtained mixture, wherein weight percentages are percentages of the total weight of the composition.

The process is simple, cost-effective using environmentally friendly solvents. The process is scalable.

In some aspects, the surfactant is sodium dodecyl sulfate. In some aspects, the organic acid catalyst is selected from the group comprising or consisting of tartaric acid, citric acid, oxalic acid, fumaric acid, maleic acid and lactic acid. In some aspects, the polymerized alkanetrialkoxysilane is hexadecyltrimethoxysilane or octadecyltrimethoxysilane.

The invention also relates to a process for manufacturing 0.5 to 10% wt solution of water glass comprising or consisting of the step of
c1) mixing a 20 to 30 wt % solution of a sodium silicate solution with 0.045 to 0.07 wt % of an organic acid catalyst, which is citric acid at room temperature,
c2) adding water to obtain a 50 ml/10 g sodium silicat solution,
c3) adjusting pH to 6 to 6.5 using HCl,
c4) precipitating the silicate,
c5) washing off sodium chloride,
c6) diluting the obtained solution to obtain 10 wt % of the inorganic component, and
c7) homogenizing the obtained solution.

The invention also relates to a process for the manufacturing of the composition as defined anywhere herein, comprising or consisting of the steps of
a) providing the solution of 0.6 to 0.9 wt % of surfactant and 0.04 to 0.08 wt % of an organic acid catalyst, and
b) add 4 to 5 wt % of C₁₀₋₃₀alkanetriC₁₋₅alkoxysilane until polymerized and homogenized
   c1) mixing a 20 to 30 wt % solution of a sodium silicate solution with 0.045 to 0.07 wt % of an organic acid catalyst, which is citric acid at room temperature,
   c 2) adding to obtain a 50 ml/10 g sodium silicat solution,
   c 3) adjusting pH to 6 to 6.5 using HCl,
   c 4) precipitating the silicate,
   c 5) washing off sodium chloride,
   c 6) diluting the obtained solution to obtain 10 wt % of the inorganic component, and
   c 7) homogenizing the obtained solution.
d) adding the solution of the inorganic component to the polymerized C₁₀₋₃₀ alkanetriC₁₋₅alkoxysilane, and
e) homogenizing the obtained mixture, wherein weight percentages are percentages of the total weight of the composition.

In some aspects, the organic acid catalyst is citric acid and the polymerized C₁₀₋₃₀ alkanetriC₁₋₅alkoxysilane is polymerized C₁₄₋₂₀alkanetrimethoxysilane. In some aspects, the polymerized C₁₀₋₃₀alkanetriC₁₋₅alkoxysilane is hexadecyltrimethoxysilane or octadecyltrimethoxysilane.

In some aspects, the inorganic component is silica dioxide gel.

In some aspects, the inorganic component is pyrogenic silica.

In some aspects, the inorganic component is crystalline silica.

In some aspects, the inorganic component is nanographite.

In some aspects, the inorganic component is water glass (WGSi).

In some aspects, the inorganic component is titanium dioxide.

In some aspects, the organic acid catalyst is citric acid.

In some aspects, homogenization is done at 6000 to 8000 rpm for 5 to 25 minutes.

The process is simple, cost-effective, and relatively quick to perform. Due to use of homogenization, the composition can be manufactured in hours rather than days. No high temperatures and high pressures are needed, nor are any environmentally unfriendly solvents used.

The invention further relates to a use of the composition as defined anywhere herein for coating or transparently coating organic and inorganic surfaces. The surfaces may be animated or non-animated. In some aspects, the surfaces are selected from the group comprising or consisting of plastics, glass, polyester, silk, fabrics, metals surface, textile, cellulose, cotton, paper sheets, cardboard, CTMP-film, polysaccharide films, cellulose-films, thermomechanical pulps film, bleach sulphite pulp sheet, filter paper, nanocellulose films and wood.

The invention further relates to a use of the composition as defined anywhere herein as a fire-resistant coating. Without the use of fluoro-alkane compounds, the coating made from the composition as defined anywhere herein is fire-resistant. This composition is less harmful for humans and nature.

In some aspects, the composition as defined anywhere herein is used as a water-repellant coating. The composition provides for a simple, cost-effective, and environmentally friendly coating on fabric, glass, paper, cardboard and other surfaces.

In some aspects, the composition as defined anywhere herein is used as an anti-sticking coating. In some aspects, the composition as defined anywhere herein is used as an anti-slipping coating. Due to the roughness of the coating as well as its stability, the coating can be used to prevent scratching, as well as slipping.

In some aspects, the composition as defined anywhere herein is used as an anti-microbial coating. In some aspects, the composition as defined anywhere herein is used as a mold-resistant coating. In some aspects, the composition as defined anywhere herein is used as a self-cleaning coating. In some aspects, the composition as defined anywhere herein is used as an anti-icing coating. In some aspects, the composition as defined anywhere herein is used as an anti-virus coating. In some aspects, the composition as defined anywhere herein is used as an anti-bacterial coating. In some aspects, the composition as defined anywhere herein is used as an anti-algae coating.

The ingredients used in the composition are not harmful for the environment, while the manufacturing costs are relatively low. Besides, the composition can be simply applied using a brush or a spray.

The composition can therefore be used for agricultural purposes, such as for protection of plants and trees, or protection of houses against molds. The composition can be used in hospitals to cover working banks, tables, and walls because of the self-cleaning and anti-microbial properties of the coating. This may save costs for cleaning such surfaces.

Boats must be cleaned regularly due to among others algae that adhere to the boat surface. The composition can be used to cover the outer boat surface to prevent algae and other plant growth on the outer surface of the boat. This may save costs for cleaning such surfaces and may also reduce fuel consumption by the boats.

The invention also relates to a method for performing a reaction between the composition as defined anywhere herein and a surface (animated or non-animated, organic or inorganic) characterized in that brushing or spraying and heat pressing is used to apply the composition on the surface. The composition is easy to apply on a surface in a cost-effective manner. No high temperatures are needed.

### BRIEF DESCRIPTION OF THE DRAWINGS

The invention will now be explained more closely by the description of different embodiments of the invention and with reference to the appended FIGURE.

FIG. 1 shows a glass surface covered by a composition of the invention comprising water-based hydrophobic nanographite.

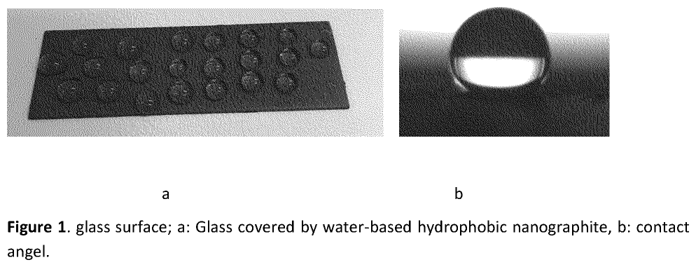

DETAILED DESCRIPTION OF VARIOUS EMBODIMENTS OF THE INVENTION

### Definitions

The definitions set forth in this application are intended to clarify terms used throughout this application. The term “herein” means the entire application.

As used herein, the term “wt %” and “% w/w” means percentages of the total weight of the composition.

As used herein, the term “optional” or “optionally” means that the subsequently described event or circumstance may but need not occur, and that the description includes instances where the event or circumstance occurs and instances where it does not.

As used herein, the terms “Cₙ”, used alone or as a suffix or prefix, is intended to include hydrocarbon-containing groups; n is an integer from 1 to 40.

The expression “from xx to yy” and “of xx to yy” means an interval from or of, and including xx, to and including yy. For example of 2 to 4 includes numbers 2.0 and 4.0 and any number in between 2.0 and 4.0.

As used herein the term “C₁₀₋₃₀alkane” used alone or as a suffix or prefix, is intended to include both saturated or unsaturated, branched or straight chain, monovalent hydrocarbon radical derived by the removal of one hydrogen atom from a single carbon atom or atom or a parent alkane, alkene or alkyne. Examples include, but are not limited to, decanyl, undecane, dodecane, tridecane, tetradecane, pentadecane, hexadecane, heptadecane, octadecane, nonadecane, icosane, henicosane, docosane, tricosane, tetracosane, pentacosane, hexacosane, heptacosane, octacosane, nonacosane, triacontane, and any stereoisomer of any of these alkanes. The term “alkyl” is specifically intended to include groups having any degree or level of saturation, including groups having exclusively single carbon-carbon bonds, groups having one or more double carbon-carbon bonds, groups having one or more triple carbon-carbon bonds, and groups having combinations of single, double, and triple carbon-carbon bonds.

As used herein, the term “alkoxy” or C₁₋₃-alkoxy”, used alone or as a suffix and prefix, refers to an alkyl radical which is attached to the remainder of the molecule through an oxygen atom. Examples of C₁₋₅-alkoxy include methoxy, ethoxy, propoxy, butoxy and pentoxy. Examples of C₁₋₃-alkoxy include methoxy, ethoxy, n-propoxy and isopropoxy.

As used herein, “polymer” refers to a chemical species or a radical made up of repeatedly linked moieties. The number of repeatedly linked moieties is 10 or higher. The linked moieties may be identical or may be a variation of moiety structures.

Composition

The invention relates to a composition that can be used as a coating that can be transparent and has a roughness and/or eveness. The composition comprises or consists of a polymerized C₁₀₋₃₀ alkanetriC₁₋₅alkoxysilane, a surfactant, an organic acid catalyst and water, and optionally an inorganic component.

The polymerized C₁₀₋₃₀ alkanetriC₁₋₅alkoxysilane may be C₁₄₋₂₀ alkanetriC₁₋₃alkoxysilane or C₁₄₋₂₄ alkanetrimethoxysilane. The polymerized C₁₀₋₃₀ alkanetriC₁₋₅alkoxysilane may be C₁₄₋₂₀alkanetrimethoxysilane or hexadecyltrimethoxysilane or octadecyltrimethoxysilane.

The amount of silane use may be from 2 to 15 wt %, or 3 to 6 wt %, or from 4 to 5 wt %, or from 4.5 to 5 wt %, when an inorganic component is present in the composition. When no inorganic compound is present in the composition, the amount of silane may be from 5 to 15 wt %, or 6 to 13 wt %.

The inorganic component may be selected from the group comprising silica dioxide gel, pyrogenic silica, crystalline silica, titanium dioxide, nanographite and water glass (WGSi). The inorganic component may be silica dioxide gel. The inorganic component may be titanium dioxide. The inorganic component may be nanographite. The inorganic component may be water glass (WGSi). The inorganic component may be pyrogenic silica. The inorganic component may be crystalline silica.

The surfactant may be any surfactant known in the art. The surfactant may be sodium dodecyl sulfate.

The amount of surfactant use may be from 0.5 to 1 wt %, or from 0.6 to 0.9 wt %, or from 0.7 to 0.85 wt %, when an inorganic component is present in the composition. When no inorganic compound is present in the composition, the amount of surfactant may be from 0.4 to 1.5 wt %, or 0.5 to 1.0 wt %.

The organic acid catalyst may be selected from the group comprising or consisting of tartaric acid, citric acid and oxalic acid. The organic acid catalyst may be citric acid. The organic acid catalyst may be tartaric acid. The organic acid catalyst may be oxalic acid. The organic acid catalyst may be selected from the group comprising or consisting of fumaric acid, maleic acid and lactic acid.

The amount of organic acid catalyst use may be from 0.01 to 0.5 wt %, or 0.02 to 0.3 wt %, or 0.03 to 0.09 wt %, or from 0.04 to 0.08 wt %, or from 0.045 to 0.07 wt %. When no inorganic compound is used in the composition, the amount of organic acid catalyst may be from 0.05 to 0.4 wt %, or 0.6 to 0.3 wt %.

The amount of inorganic component use may be from 0.5 to 10 wt %, or 3 to 10 wt %, or 0.5 to 5.5 wt %, 1 to 4 wt %, or 4 to 5 wt %, or 0.5 to 3.5 wt % or 2 to 3 wt %, or 1.5 to 3.5 wt %, or 2.1 to 2.9 wt %. The amount of inorganic component may be varied depending on the application of the coating. For fire resistance for example, the coating may comprise 5 to 10 wt % of an inorganic component, such as silica dioxide.

The invention relates to a composition comprising or consisting of any combination of ingredients mentioned herein.

The composition may comprise or consist of
4 to 10 wt % of polymerized C₁₀₋₃₀alkanetri C₁₋₅alkoxysilane,
0.6 to 0.9 wt % of surfactant,
0.04 to 0.2 wt % or 0.04 to 0.08 wt % of organic catalyst,
0.5 to 5 wt % of an inorganic component selected from the group comprising or consisting of silica dioxide gel, pyrogenic silica, crystalline silica and titanium dioxide, and
up to 100 wt % water.

The surfactant may be sodium dodecyl sulfate. The organic acid catalyst may be selected from the group comprising or consisting of tartaric acid, citric acid, oxalic acid, fumaric acid, maleic acid and lactic acid. The polymerized alkanetrialkoxysilane may be hexadecyltrimethoxysilane or octadecyltrimethoxysilane.

The composition may comprise or consist of
4 to 5 wt % of polymerized C₁₀₋₃₀alkanetri C₁₋₅alkoxysilane,
0.6 to 0.9 wt % of surfactant,
0.04 to 0.2 wt % or 0.04 to 0.08 wt % of organic catalyst,
0.5 to 10 wt % of an inorganic component selected from the group comprising or consisting of nanographite, nanographene and water glass (WGSi), and
up to 100 wt % water.

The surfactant may be sodium dodecyl sulfate. The organic acid catalyst may be selected from the group comprising or consisting of tartaric acid, citric acid, oxalic acid, fumaric acid, maleic acid and lactic acid. The polymerized alkanetrialkoxysilane may be hexadecyltrimethoxysilane or octadecyltrimethoxysilane.

The composition may comprise or consist of
4 to 10 wt % of polymerized C₁₀₋₃₀alkanetri C₁₋₅alkoxysilane,
0.6 to 0.9 wt % of surfactant,
0.04 to 0.2 wt % or 0.04 to 0.08 wt % of organic catalyst be selected from the group comprising or consisting of tartaric acid, citric acid and oxalic acid,
0.5 to 10 wt % of an inorganic component selected from the group comprising or consisting of silica dioxide gel, pyrogenic silica, crystalline silica and titanium dioxide, and
up to 100 wt % water.

The surfactant may be sodium dodecyl sulfate. The polymerized alkanetrialkoxysilane may be hexadecyltrimethoxysilane or octadecyltrimethoxysilane.

The composition may comprise or consist of
4 to 5 wt % of polymerized C₁₀₋₃₀alkanetri C₁₋₅alkoxysilane,
0.6 to 0.9 wt % of surfactant,
0.04 to 0.2 wt % or 0.04 to 0.08 wt % of organic catalyst be selected from the group comprising or consisting of fumaric acid, maleic acid and lactic acid,
0.5 to 10 wt % of an inorganic component selected from the group comprising or consisting of nanographite, nanographene and water glass (WGSi), and
up to 100 wt % water.

The surfactant may be sodium dodecyl sulfate. The polymerized alkanetrialkoxysilane may be hexadecyltrimethoxysilane or octadecyltrimethoxysilane.

The composition may comprise or consist of
4 to 15 wt %, or 5 to 13 wt % of polymerized C₁₀₋₃₀alkanetri C₁₋₅ alkoxysilane,
0.4 to 1.2 wt %, or 0.5 to 1.0 wt % of surfactant,
0.05 to 0.3 wt % or 0.06 to 0.28 wt % of organic catalyst, and
up to 100 wt % water.

The surfactant may be sodium dodecyl sulfate. The organic acid catalyst may be selected from the group comprising or consisting of tartaric acid, citric acid, oxalic acid, fumaric acid, maleic acid and lactic acid. The polymerized alkanetrialkoxysilane may be hexadecyltrimethoxysilane or octadecyltrimethoxysilane.

The composition may comprise or consist of
4 to 15 wt %, or 6 to 13 wt % of polymerized C₁₀₋₃₀ alkanetri C₁₋₅ alkoxysilane,
0.4 to 1.2 wt %, or 0.5 to 1.0 wt % of surfactant,
0.05 to 0.3 wt % or 0.06 to 0.28 wt % of organic catalyst, selected from the group comprising or consisting of tartaric acid, citric acid and oxalic acid, and up to 100 wt % water.

The surfactant may be sodium dodecyl sulfate. The polymerized alkanetrialkoxysilane may be hexadecyltrimethoxysilane or octadecyltrimethoxysilane.

The composition may comprise or consist of
4 to 15 wt %, or 10 to 13 wt % of polymerized C₁₀₋₃₀alkanetri C₁₋₅ alkoxysilane, 0.4 to 1.2 wt %, or 0.75 to 1.25 wt % of surfactant,
0.05 to 0.3 wt % or 0.06 to 0.2 wt % of organic catalyst, selected from the group comprising or consisting of fumaric acid, maleic acid and lactic acid
up to 100 wt % water.

The surfactant may be sodium dodecyl sulfate. The polymerized alkanetrialkoxysilane may be hexadecyltrimethoxysilane or octadecyltrimethoxysilane.

The composition may thus comprise or consist of
4 to 5 wt % or 4.5 to 5 wt % of polymerized C₁₆₋₁₈ alkanetrimethoxysilane,
0.6 to 0.9 wt % or 0.7 to 0.85 wt % of surfactant, which is sodium dodecyl sulfate,
0.04 to 0.08 wt % or 0.045 to 0.07 wt % of an organic acid catalyst selected from the group comprising or consisting of tartaric acid, citric acid and oxalic acid,
0.5 to 3.5 wt % or 1 to 3 wt % of an inorganic component, which is silica dioxide gel, and
up to 100 wt % water, or
the composition may comprise or consist of
4 to 10 wt % or 4.5 to 5 wt % of polymerized C₁₆₋₁₈ alkanetrimethoxysilane,
0.6 to 0.9 wt % or 0.7 to 0.85 wt % of surfactant, which is sodium dodecyl sulfate,
0.04 to 0.2 wt % or 0.045 to 0.07 wt % of an organic acid catalyst selected from the group comprising or consisting of tartaric acid, citric acid, oxalic acid, fumaric acid, maleic acid and lactic acid,
0.5 to 3.5 wt % or 1 to 3 wt % of an inorganic component, which is pyrogenic silica, and
up to 100 wt % water, or
the composition may comprise or consist of
4 to 10 wt % or 4.5 to 5 wt % of polymerized C₁₆₋₁₈ alkanetrimethoxysilane,
0.6 to 0.9 wt % or 0.7 to 0.85 wt % of surfactant, which is sodium dodecyl sulfate,
0.04 to 0.2 wt % or 0.045 to 0.07 wt % of an organic acid catalyst selected from the group comprising or consisting of tartaric acid, citric acid and oxalic acid,
0.5 to 5 wt % or 0.5 to 3.5 wt % or 1 to 3 wt % of an inorganic component, which is crystalline silica, and
up to 100 wt % water, or
the composition may comprise or consist of
4 to 5 wt % or 4.5 to 5 wt % of polymerized C₁₆₋₁₈ alkanetrimethoxysilane,
0.6 to 0.9 wt % or 0.7 to 0.85 wt % of surfactant, which is sodium dodecyl sulfate,
0.04 to 0.08 wt % or 0.045 to 0.07 wt % of an organic acid catalyst selected from the group comprising or consisting of tartaric acid, citric acid and oxalic acid,
0.5 to 5.5 wt % or 4 to 5 wt % of an inorganic component, which is titanium dioxide, and
up to 100 wt % water, or
the composition may comprise or consist of
4 to 5 wt % or 4.5 to 5 wt % of polymerized C₁₆₋₁₈alkanetrimethoxysilane,
0.6 to 0.9 wt % or 0.7 to 0.85 wt % of surfactant, which is sodium dodecyl sulfate,
0.04 to 0.08 wt % or 0.045 to 0.07 wt % of an organic acid catalyst selected from the group comprising or consisting of tartaric acid, citric acid and oxalic acid,
0.5 to 3.5 wt % or 2 to 3 wt % of an inorganic component, which is nanographite, and
up to 100 wt % water, or

The composition may comprise or consist of
4 to 5 wt % or 4.5 to 5 wt % of polymerized C₁₆₋₁₈alkanetrimethoxysilane,
0.6 to 0.9 wt % or 0.7 to 0.85 wt % of surfactant, which is sodium dodecyl sulfate,
0.04 to 0.08 wt % or 0.045 to 0.07 wt % of an organic acid catalyst selected from the group comprising or consisting of tartaric acid, citric acid and oxalic acid,
0.5 to 3.5 wt % or 2 to 3 wt % of an inorganic component, which is water glass (WGSi), and up to 100 wt % water.

The composition may comprise or consist of
4 to 5 wt % or 4.5 to 5 wt % of polymerized C₁₆₋₁₈alkanetrimethoxysilane,
0.6 to 0.9 wt % or 0.7 to 0.85 wt % of surfactant, which is sodium dodecyl sulfate,
0.04 to 0.08 wt % or 0.045 to 0.07 wt % of an organic acid catalyst, which is tartaric acid,
0.5 to 3.5 wt % or 2 to 3 wt % or 3.0 to 5.5 wt % or 3.5 to 5 wt % of an inorganic component selected from the group comprising or consisting of silica dioxide gel, pyrogenic silica, crystalline silica, titanium dioxide, nanographite, and water glass (WGSi), and
up to 100 wt % water, or
the composition may comprise or consist of
4 to 10 wt % or 4.5 to 5 wt % of polymerized C₁₆₋₁₈alkanetrimethoxysilane,
0.6 to 0.9 wt % or 0.7 to 0.85 wt % of surfactant, which is sodium dodecyl sulfate,
0.04 to 0.2 wt % or 0.045 to 0.07 wt % of an organic acid catalyst, which is citric acid,
0.5 to 6 wt % or 0.5 to 3.5 wt % or 2 to 3 wt % or 3.0 to 5.5 wt % or 3.5 to 5 wt % of an inorganic component selected from the group comprising or consisting of silica dioxide gel, pyrogenic silica, crystalline silica, titaniumdioxide, nanographite and water glass (WGSi), and
up to 100 wt % water, or
the composition may comprise or consist of
4 to 5 wt % or 4.5 to 5 wt % of polymerized C₁₆₋₁₈alkanetrimethoxysilane,
0.6 to 0.9 wt % or 0.7 to 0.85 wt % of surfactant, which is sodium dodecyl sulfate,
0.04 to 0.08 wt % or 0.045 to 0.07 wt % of an organic acid catalyst, which is oxalic acid,
0.5 to 6 wt % or 0.5 to 3.5 wt % or 2 to 3 wt % or 3.0 to 5.5 wt % or 3.5 to 5 wt % of an inorganic component selected from the group comprising or consisting of silica dioxide gel, pyrogenic silica, crystalline silica titanium dioxide, nanographite and water glass (WGSi), and
up to 100 wt % water.

The composition may comprise or consist of
4 to 10 wt % or 4.5 to 5 wt % of polymerized C₁₆₋₁₈alkanetrimethoxysilane,
0.6 to 0.9 wt % or 0.7 to 0.85 wt % of surfactant, which is sodium dodecyl sulfate,
0.04 to 0.2 wt % or 0.045 to 0.07 wt % of an organic acid catalyst, which is citric acid,
0.5 to 3.5 wt % or 2 to 3 wt % of an inorganic component, which is silica dioxide gel, and up to 100 wt % water, or
the composition may comprise or consist of
4 to 5 wt % or 4.5 to 5 wt % of polymerized C₁₆₋₁₈alkanetrimethoxysilane,
0.6 to 0.9 wt % or 0.7 to 0.85 wt % of surfactant, which is sodium dodecyl sulfate,
0.04 to 0.08 wt % or 0.045 to 0.07 wt % of an organic acid catalyst, which is citric acid,
0.5 to 3.5 wt % or 2 to 3 wt % of an inorganic component, which is pyrogenic silica, and
up to 100 wt % water, or
the composition may comprise or consist of
4 to 5 wt % or 4.5 to 5 wt % of polymerized C₁₆₋₁₈alkanetrimethoxysilane,
0.6 to 0.9 wt % or 0.7 to 0.85 wt % of surfactant, which is sodium dodecyl sulfate,
0.04 to 0.08 wt % or 0.045 to 0.07 wt % of an organic acid catalyst, which is citric acid,
0.5 to 3.5 wt % or 2 to 3 wt % of an inorganic component, which is crystalline silica, and
up to 100 wt % water, or
the composition may comprise or consist of
4 to 5 wt % or 4.5 to 5 wt % of polymerized C₁₆₋₁₈alkanetrimethoxysilane,
0.6 to 0.9 wt % or 0.7 to 0.85 wt % of surfactant, which is sodium dodecyl sulfate,
0.04 to 0.08 wt % or 0.045 to 0.07 wt % of an organic acid catalyst, which is citric acid,
0.5 to 5.5 wt % or 3 to 5 wt % of an inorganic component, which is titanium dioxide, and up to 100 wt % water, or
the composition may comprise or consist of
4 to 5 wt % or 4.5 to 5 wt % of polymerized C₁₆₋₁₈ alkanetrimethoxysilane,
0.6 to 0.9 wt % or 0.7 to 0.85 wt % of surfactant, which is sodium dodecyl sulfate,
0.04 to 0.08 wt % or 0.045 to 0.07 wt % of an organic acid catalyst which is citric acid,
0.5 to 3.5 wt % or 2 to 3 wt % of an inorganic component, which is nanographite, and
up to 100 wt % water, or
the composition may comprise or consist of
4 to 5 wt % or 4.5 to 5 wt % of polymerized C₁₆₋₁₈ alkanetrimethoxysilane,
0.6 to 0.9 wt % or 0.7 to 0.85 wt % of surfactant, which is sodium dodecyl sulfate,
0.04 to 0.08 wt % or 0.045 to 0.07 wt % of an organic acid catalyst which is citric acid,
0.5 to 3.5 wt % or 2 to 3 wt % of an inorganic component, which is water glass (WGSi), and
up to 100 wt % water.

Manufacturing

The invention also relates to a process for the manufacturing of the composition as defined anywhere herein comprising or consisting of the step of
a) providing the solution of 0.5 to 1.5 wt % or 0.6 to 0.9 wt % of surfactant and 0.04 to 0.5 wt %, or 0.05 to 0.3 wt %, or 0.04 to 0.08 wt % of an organic acid catalyst,
b) adding 5 to 15 wt %, or 6 to 12.5 wt %, or 2 to 5 wt %, or 4 to 5 wt % of C₁₀₋₃₀ alkanetriC₁₋₅alkoxysilane until polymerized and homogenized
c) optionally, providing 0.5 to 10% wt or 2 to 5% wt solution of the inorganic component,
d) optionally adding the solution of the inorganic component to the polymerized C₁₀₋₃₀alkanetriC₁₋₅alkoxysilane, and
e) homogenizing the obtained mixture, wherein weight percentages are percentages of the total weight of the composition.

The process for the manufacturing of the composition as defined anywhere herein may comprise or consist of the step of
a) providing the solution of 0.4 to 1.5 wt % of surfactant and 0.04 to 0.3 wt % of tartaric acid, citric acid or oxalic acid, or fumaric acid, maleic acid and lactic acid,
b) adding 3 to 15 wt % of C₁₆₋₁₈ alkanetriC₁₋₃alkoxysilane until polymerized and homogenized,
c) providing 0.5 to 10 wt % solution of inorganic component selected from the group comprising or consisting of silica dioxide gel (e.g. 2.4 wt % of total composition), pyrogenic silica (e.g. 2.4 wt % of total composition), crystalline silica (e.g. 2.4 wt % of total composition), titanium dioxide (e.g. 2.4 wt % of total composition), nanographite water glass (WGSi) (e.g. 2.4 wt % of total composition), or titanium oxide (e.g. 4.6 wt % of total composition),
d) adding the 0.5 to 10 wt % solution of step c) to the polymerized C₁₆₋₁₈alkanetriC₁₋₃alkoxysilane, and
e) homogenizing the obtained mixture, wherein weight percentages are percentages of the total weight of the composition.

The surfactant may be sodium dodecyl sulfate. The organic acid catalyst may be selected from the group comprising or consisting of tartaric acid, citric acid, oxalic acid. The organic acid catalyst may be selected from the group comprising or consisting of fumaric acid, maleic acid and lactic acid. The polymerized alkanetrialkoxysilane may be hexadecyltrimethoxysilane or octadecyltrimethoxysilane. The inorganic component may be selected from the group comprising or consisting of silica dioxide gel, pyrogenic silica, crystalline silica and titanium dioxide. The inorganic component may be selected from the group comprising or consisting of nanographite, nanographene and water glass (WGSi).

The process for the manufacturing of the composition as defined anywhere herein may comprise or consist of the step of
a) providing the solution of 0.6 to 0.9 wt % of surfactant and 0.04 to 0.08 wt % of citric acid,
b) adding 4 to 5 wt % of C₁₆₋₁₈alkanetriC₁₋₃alkoxysilane until polymerized and homogenized,
c) providing 0.5 to 10 wt % solution of silica dioxide gel (e.g. 2.4 wt % of total composition), pyrogenic silica (e.g. 2.4 wt % of total composition), crystalline silica (e.g. 2.4 wt % of total composition), titanium dioxide (e.g. 2.4 wt % of total composition), nanographite water glass (WGSi) (e.g. 2.4 wt % of total composition), or titanium oxide (e.g. 4.6 wt % of total composition),
d) adding the 0.5 to 10 wt % solution of step c) to the polymerized C₁₆₋₁₈alkanetriC₁₋₃alkoxysilane, and
e) homogenizing the obtained mixture, wherein weight percentages are percentages of the total weight of the composition.

The invention also relates to a method for performing a reaction between the as defined anywhere herein and a surface (animated or non-animated, organic or inorganic). The composition is first applied on the surface, e.g. by brushing or spraying. Then, the composition may be heat pressed to attach or fixedly attach the composition on the surface.

Use

The composition as defined anywhere herein may be applied to a surface using a brush or by penselling the composition on a surface. Alternatively, the composition may be sprayed on a surface.

The composition may be applied on a surface using hot pressing. A method for applying the composition on a surface may comprise or consist of the step of applying the composition on a surface, pressing the covered surface using a heated sheet at a temperature above 40° C., or above 60° C., or above 90° C. at a pressure of at least 50 kPa, or at least 60 kPa, or at least 90 kPa for 10 to 30 minutes. The method for applying the composition on a surface may for example comprise or consist of the step of applying the composition on a surface, pressing the surface using a heated sheet at a temperature above 90° C., or between 90 and 100° C. at a pressure of at least 95 kPa, or between 90 and 100 kPa, for 15 to 25 minutes.

The mathos is simple, inexpensive, quick and scalable.

The surfaces may be made of organic or inorganic material, or mixtures thereof. The surface may be a fabric, cotton, textile, polyester, silk and glass. Other examples of surfaces are metal, plastics and wood materials.

Examples of paper that may be used are Chemomechnical pulp, Bleash sulphite pulp, nanopaper, CNC-film, paper board, thermomechanical pulp, filter paper, greaseproof paper, rice paper.

The obtained coating has water-repellent, fire-resistant, microbial-resistant and mold-resistant properties. The application can thus be used as coating on all kinds of surfaces where any such properties are desired, such as on working stations in hospitals, walls, interior and exterior surfaces of houses and boats and even on plants and trees.

### EXPERIMENT

Material and Method

Citric acid, Tartaric acid, Oxalic acid, Hexadecyl trimethoxy silane (85%), Octadecyl trimethoxy silane (90%), Silica gel high grade (w/Ca, about 0.1%), pore size 60 Å, 230-400 mesh particle size, Sodium silicate solution (25-28%), TiO₂, Sigma Aldrich. pyrogenic silica, Wacker.

Sodium dodecyl sulphate (SDS), VWR chemicals.

Silica particles were prepared from Sodium silicate solution (25-28%) in the lab.

Emulsion homogenizing was made using an ULTRA TURRAX mixer (IKA T 25 digital).

Drying of samples was done in Rapid Kothen (RK) sheet former at 93° C. at an applied pressure of 96 kPa for 20 minutes.

The water contact angle was recorded on PGX+ contact angle analyzer—Pocket Goniometer.

Emulsions Preparation as a Water Based Hydrophobic Material

Polymerization of Silanes

In a 250 ml round-bottom flask, sodium dodecyl sulphate (1.15 g, 4 mmol) was dissolved in distilled water (100 ml) by stirring slowly for 30 minutes at room temperature. Then, citric acid (100 mg, 0.52 mmol) was added to the mixture and followed by stirring for 5 minutes, the temperature was fixed at 40° C. and hexadecyl trimethoxy silane (85%, 8 ml, 17.5 mmol) was added dropwise and stirred for 5 minutes. Then the reaction was continued at 40° C. in static condition for 48 hours. After that, the mixture was homogenized using an ULTRA TURRAX mixer (IKA T 25 digital) at 6000 rpm for 5 minutes.

Preparing Silica Particles from Sodium Silicate Solution (Water Glass)

Citric acid (1 M, 4 ml) was added slowly in a sodium silicate solution (25-28%, 10 g) at room temperature. The silica particles precipitated. Distilled water (50 ml) was added and pH was fixed by adding HCl (2 M) at 6-6.5 and washed using distilled water until the NaCl salt was removed totally. The supernatant was checked by AgNO₃ solution (1 M). The mixture was diluted with distilled water to 10% of silica particles suspension and homogenized using ULTRA TURRAX mixer (IKA T 25 digital) at 7000 rpm for 10 minutes. These particles are herein referred to as WGSi.

Preparation of the Compositions

Inorganic particles (SiO₂, WGSi, TiO₂ or nanographite) suspension was added to the polymerized silane and homogenized at 6000 rpm for 1 minute.

### Example 1

2.3 g SDS (0.78% w/w), 0.2 g citric acid (0.068% w/w), 13.8 g hexadecyltrimethoxy silane (4.6% w/w), 7.2 g silica gel (2.4% w/w), 200 g water (polymerization step), 72 g water with 10% w/w suspending inorganic component, total water (92% w/w). (Total amount emulsified liquid composition=295 g), final pH=3.2.

### Example 2

2.3 g SDS (0.78% w/w), 0.15 g tartaric acid (0.05% w/w), 13.8 g hexadecyltrimethoxy silane (4.6% w/w), 7.2 g silica gel (2.4% w/w), 200 g water (polymerization step), 72 g water with 10% w/w suspending inorganic component, total water (92% w/w). (Total amount emulsified liquid composition=295 g), final pH=3.4.

### Example 3

2.3 g SDS (0.78% w/w), 0.1 g oxalic acid (0.05% w/w), 13.8 g hexadecyltrimethoxy silane (4.6% w/w), 7.2 g silica gel (2.4% w/w), 200 g water (polymerization step), 72 g water with 10% w/w suspending inorganic component, total water (92% w/w). (Total amount emulsified liquid composition=295 g), final pH=2.8.

### Example 4

2.3 g SDS (0.78% w/w), 0.2 g citric acid (0.068% w/w), 15 g octadecyltrimethoxy silane (5% w/w), 7.2 g silica gel (2.4% w/w), 200 g water (polymerization step), 72 g water with 10% w/w suspending inorganic component, total water (92% w/w). (Total amount emulsified liquid composition=296 g), final pH=3.2.

### Example 5

2.3 g SDS (0.78% w/w), 0.2 g citric acid (0.068% w/w), 13.8 g hexadecyltrimethoxy silane (4.6% w/w), 7.2 g WGSi (SiO₂ 2.4% w/w), 200 g water (polymerization step), 72 g water with 10% w/w suspending inorganic component, total water (92% w/w). (Total amount emulsified liquid composition=295 g), final pH=9.5.

### Example 6

2.3 g SDS (0.76% w/w), 0.2 g citric acid (0.066% w/w), 13.8 g hexadecyltrimethoxy silane (4.5% w/w), 14.4 g TiO₂ (4.6% w/w), 200 g water (polymerization step), 72 g water with 20% w/w suspending inorganic component, total water (90% w/w). (Total amount emulsified liquid composition=302 g), final pH=3.2.

### Example 7

2.3 g SDS (0.78% w/w), 0.2 g citric acid (0.068% w/w), 13.8 g hexadecyltrimethoxy silane (4.6% w/w), 7.2 g nanographite (2.4% w/w), 200 g water (polymerization step), 72 g water (suspending inorganic component), total water (92% w/w). (Total amount emulsified liquid composition=295 g), final pH=3.2.

### Example 8

2.3 g SDS (0.78% w/w), 0.2 g citric acid (0.068% w/w), 13.8 g hexadecyltrimethoxy silane (4.6% w/w), 7.2 g pyrogenic silica (2.4% w/w), 200 g water (polymerization step), 72 g water with 10% w/w suspending inorganic component, total water (92% w/w). (Total amount emulsified liquid composition=295 g), final pH=3.0.

Applying the water-based formula on the surface The composition was applied on the surface by coating or spraying. The modified surface left at room temperature until the materials were adsorbed by the surface. This time varies between 20-30 minutes depending on the composition and surface. A surface area of 20 cm 2 was covered with 0.74-0.76-gram material by penciling and 0.64-0.66 gram using spray. For the reaction between the chemicals and surface either Rapid-kothen (RK) sheet former or Rotopress were used. Rapid-kothen sheet former was used at 93° C. at an applied pressure of 96 kPa for 20 minutes, and the Rotopress was used at 260° C., at a pressure of 8 MPa, with a speed of 3 m/min.

TABLE 1
applying the suspension on diverse surfaces.

| | | | covering the | | Contact |
|---|---|---|---|---|---|
| Entry ^{a} | Suspension | particles | surface | surface | Angel ^{b} |
| 1 | EX 1, pH: 3.2 | SiO₂ from | Coating | CNC-coated paper | 145 |
| | | silica gel | | CTMP | 147 |
| | | | | Wood | 147 |
| 2 | EX 2, pH: 3.4 | SiO₂ from | Coating | CNC-coated paper | 140 |
| | | silica gel | | CTMP | 148 |
| 3 | EX 3, pH: 2.8 | SiO₂ from | Coating | CNC-coated paper | 139 |
| | | silica gel | | CTMP | 147 |
| 4 | EX 4, pH: 3.2 | SiO₂ from | Coating | CNC-coated paper | 147 |
| | | silica gel | | CTMP | 144 |
| | | | | Wood | 145 |
| 5 | Ex 5, pH: 9.5 | WGSi | Coating | CNC-coated paper | 149 |
| | | | | CTMP | 150 |
| | | | | Wood | 148 |
| 6 | Ex 5, pH: 9.5 | WGSi | Spray | CNC-coated paper | 147 |
| | | | | Cotton | 144 |
| | | | | Silk | 144 |
| | | | | Silk ^{c} | 144 |
| | | | | CNC film - rough surface | 147 |
| | | | | CNC film - smooth surface | 141 |
| | | | | wood | 144 |
| 7 | Ex 6, pH: 3.2 | TiO₂ | Coating | CNC-coated paper | 146 |
| | | | | CTMP | 142 |
| 8 | Ex 7, pH: 3.2 | Nanographite | Coating | CNC-coated paper | 143 |
| 9 | Ex 7, pH: 3.2 | Nanographite | Spray | CTMP | 142 |
| | | | | Filter paper | 134 |
| | | | | Glass ^{d} | 140 |
| 10 | EX 8, pH: 3.0 | Pyrogenic silica | Spray | CNC-coated paper | 153 |
| | | | | Filter paper | 156 |
| | | | | CTMP | 158 |
| | | | | Silk | 157 |
| | | | | wood | 154 |
| 11^{e} | Ex 5, pH: 9.5 | WGSi | Spray | CNC-coated paper | 130 |
| | | | Coating | CNC-coated paper | 130 |

^{a} The surface was covered by the composition using a dipp coating, brushing or spray and dried by RK sheet former at 93° C. for 20 minutes.
^{b} Mean value of three measurements.
^{c} The modified silk was washed at 45° C. for 90 minutes, then a contact angel was measured.
^{d} The surface was dried after first spray and second spray was applied to cover the surface properly
^{e}The size of samples were A4 and for drying, Rotopress was used at 260° C., at a pressure of 8 MPa, and at a speed of 3 m/min.
CTMP = chemi-thermomechanical pulp
CNC = Cellulose Nanocrystals

### Example 9

Polymerization of Silanes

In a 250 ml round-bottom flask, flushed with milli-Q water (200 ml), sodium dodecyl sulphate (2.3 g, 8 mmol) was added and stirred slowly for 30 minutes at room temperature. Then, citric acid (200 mg, 1 mmol) was added to the mixture and followed by stirring for 5 minutes, and hexadecyl trimethoxy silane (85%, 14 g) was added slowly and stirred for 5 minutes. Afterwards, the reaction was continued at 40° C. in static condition for 2 hours. Then, the mixture was kept in room temperature (i.e. of 16 to 28° C.) for an additional 46 hours. the prepared suspension was mixed at room temperature for 1 hour at 1400 rpm.

Entry 12.3 g SDS (1% w/w), 0.2 g citric acid (0.09% w/w), 14 g hexadecyltrimethoxy silane (6.5% w/w), 200 g water, final pH=3.0.

Entry 22.3 g SDS (1% w/w), 0.3 g citric acid (0.14% w/w), 14 g hexadecyltrimethoxy silane (6.5% w/w), 200 g water, final pH=2.9.

Entry 3 2.3 SDS (1% w/w), 0.4 g citric acid (0.18% w/w), 14 g hexadecyltrimethoxy silane (6.5% w/w), 200 g water, final pH=2.8.

Entry 42.3 g SDS (1% w/w), 0.6 g citric acid (0.27% w/w), 14 g hexadecyltrimethoxy silane (6.5% w/w), 200 g water, final pH=2.7.

Entry 5 2.3 g SDS (1% w/w), 0.28 g tartaric acid (0.14% w/w), 14 g hexadecyltrimethoxy silane (6.5% w/w), 200 g water, final pH=2.8.

Entry 6 2.3 g SDS (1% w/w), 0.4 g citric acid (0.18% w/w), 14.5 g octadecyltrimethoxy silane (6.7% w/w), 200 g water, final pH=2.8.

Entry 7 2.3 g SDS (1% w/w), 0.4 g citric acid (0.17% w/w), 28 g hexadecyltrimethoxy silane (12% w/w), 200 g water, final pH=2.8.

Entry 8 2.3 g SDS (1% w/w), 0.4 g citric acid (0.17% w/w), 29 g octadecyltrimethoxy silane (12.4% w/w), 200 g water, final pH=2.8.

Entry 9 2.3 g SDS (0.78% w/w), 0.4 g citric acid (0.14% w/w), 14 g hexadecyltrimethoxy silane (4.6% w/w), 7.2 g pyrogenic silica (2.4% w/w), 200 g water (polymerization step), 72 g water with 10% w/w suspending inorganic component, total water (92% w/w), final pH=3.0.

Entry 10 2.3 g SDS (0.74% w/w), 0.4 g citric acid (0.13% w/w), 28 g hexadecyltrimethoxy silane (9% w/w), 7.2 g pyrogenic silica (2.3% w/w), 200 g water (polymerization step), 72 g water with 10% w/w suspending inorganic component, total water (87% w/w), final pH=3.1.

Entry 11 2.3 g SDS (0.78% w/w), 0.2 g citric acid (0.07% w/w), 14 g hexadecyltrimethoxy silane (4.6% w/w), 7.2 g nanographite (2.4% w/w), 200 g water (polymerization step), 72 g water with 10% w/w suspending inorganic component, total water (92% w/w), final pH=3.0.

Entry 12 2.3 g SDS (1% w/w), 0.22 g fumaric acid (0.1% w/w), 28 g hexadecyltrimethoxy silane (12% w/w), 200 g water, final pH=2.8.

Entry 13 2.3 g SDS (1% w/w), 0.17 g lactic acid (0.07% w/w), 28 g hexadecyltrimethoxy silane (12% w/w), 200 g water, final pH=3.0.

Entry 14 2.3 g SDS (1% w/w), 0.22 g maleic acid (0.1% w/w), 28 g hexadecyltrimethoxy silane (12% w/w), 200 g water, final pH=2.4.

Entry 15 1.15 g SDS (0.5% w/w), 0.4 g citric acid (0.17% w/w), 29 g octadecyltrimethoxy silane (12.4% w/w), 200 g water, final pH=2.8.

Entry 16 1.15 g SDS (0.5% w/w), 0.4 g citric acid (0.17% w/w), 28 g hexadecyltrimethoxy silane (12% w/w), 200 g water, final pH=2.8.

Entry 17 2.3 g SDS (0.78% w/w), 0.22 g fumaric acid (0.07% w/w), 14 g hexadecyltrimethoxy silane (4.6% w/w), 7.2 g pyrogenic silica (2.4% w/w), 200 g water (polymerization step), 72 g water with 10% w/w suspending inorganic component, total water (92% w/w), final pH=2.8.

Entry 18 2.3 g SDS (0.78% w/w), 0.17 g lactic acid (0.06% w/w), 14 g hexadecyltrimethoxy silane (4.6% w/w), 7.2 g pyrogenic silica (2.4% w/w), 200 g water (polymerization step), 72 g water with 10% w/w suspending inorganic component, total water (92% w/w), final pH=3.0.

Entry 19 2.3 g SDS (0.78% w/w), 0.22 g maleic acid (0.07% w/w), 14 g hexadecyltrimethoxy silane (4.6% w/w), 7.2 g pyrogenic silica (2.4% w/w), 200 g water (polymerization step), 72 g water with 10% w/w suspending inorganic component, total water (92% w/w), final pH=2.5.

Entry 20 2.3 g Brij® C₁₀ (1% w/w), 0.4 g citric acid (0.17% w/w), 28 g hexadecyltrimethoxy silane (12% w/w), 200 g water, final pH=2.7.

Entry 21 2.3 g Berol 02 (1% w/w), 0.4 g citric acid (0.17% w/w), 28 g hexadecyltrimethoxy silane (12% w/w), 200 g water, final pH=2.6.

TABLE 2
applying the suspension on diverse surfaces.

| Entry ^{a} | Suspension | Inorganic particles | Substrate | Contact Angel ^{b} |
|---|---|---|---|---|
| 1 | EX 1, pH: 3.0 | — | Filter Paper | 120 |
| 2 | EX 2, pH: 2.9 | — | Filter Paper | 120 |
| 3 | EX 3, pH: 2.8 | — | Filter Paper | 133 |
| 4 | EX 4, pH: 2.7 | — | Filter Paper | 133 |
| 5 | Ex 5, pH: 2.8 | — | CNC film | 144 |
| 6 | Ex 6, pH: 2.8 | — | Filter Paper | 140 |
| 7 | Ex 7, pH: 2.8 | — | Filter Paper | 150 |
| | | | CNC film | 152 |
| 8 | Ex 8, pH: 2.8 | — | Filter Paper | 149 |
| | | | CNC film | 152 |
| 9 | Ex 9, pH: 3.0 | Pyrogenic silica | Filter paper | 157 |
| | | | Paper (kraft liner 170 g/m²) | 152 |
| 10 | EX 10, pH: 3.1 | Pyrogenic silica | Filter paper | 152 |
| 11 | EX 11, pH: 3.0 | nanographite | Paper (Exopress 72, 49 g/m²) | 140 |
| 12 | EX 12, pH: 2.8 | — | Filter Paper | 133 |
| 13 | EX 13, pH: 3.0 | — | Filter Paper | 140 |
| 14 | EX 14, pH: 2.4 | — | Filter Paper | 132 |
| 15 | EX 15, pH: 2.8 | — | Filter Paper | 142 |
| 16 | EX 16, pH: 2.8 | — | Filter Paper | 134 |
| 17 | EX 17, pH: 2.8 | Pyrogenic silica | Filter paper | 150 |
| 18 | EX 18, pH: 3.0 | Pyrogenic silica | Filter paper | 157 |
| 19 | EX 19, pH: 2.5 | Pyrogenic silica | Filter paper | 157 |
| 20 | EX 20, pH: 2.7 | — | Filter paper | 0.00 |
| 21 | EX 21, pH: 2.6 | — | Filter paper | 0.00 |
| 22 | Commercial OrganoTex | | Filter paper | 125 |
| | pH: 4.7 | | | |

^{a} The surface of substrates were treated by suspension using spray, and the RK sheet former was used to complete the reaction at 93° C. for 20 minutes.
^{b} Mean value of three measurements.

The present invention is not limited to the embodiments disclosed but may be varied and modified within the scope of the following claims.

1. A composition comprises
2 to 15 wt % of a polymerized C₁₀₋₃₀alkanetriC₁₋₅alkoxysilane,
0.3 to 1.5 wt % of a surfactant,
wherein the surfactant is sodium dodecyl sulfate,
0.04 to 0.40 wt % of an organic acid catalyst,
optionally 0.5 to 10 wt % of an inorganic component selected from the group consisting of: silica dioxide gel, pyrogenic silica, crystalline silica, titanium dioxide, nanographite, nanographene and water glass (WGSi), and
up to 100 wt % water, wherein weight percentages are percentages of the total weight of the composition and wherein water is the only solvent.

2. The composition according to claim 1, comprising
4 to 9 wt % of a polymerized C₁₀₋₃₀alkanetriC₁₋₅alkoxysilane,
0.6 to 0.9 wt % of a surfactant,
0.04 to 0.20 wt % of an organic acid catalyst,
0.5 to 10 wt % of an inorganic component selected from the group consisting of: silica dioxide gel, pyrogenic silica, crystalline silica, titanium dioxide, nanographite, nanographene and water glass (WGSi), and
up to 100 wt % water, wherein weight percentages are percentages of the total weight of the composition.

3. The composition according to claim 1, comprising
4 to 5 wt % of a polymerized C₁₀₋₃₀alkanetriC₁₋₅alkoxysilane,
0.6 to 0.9 wt % of a surfactant,
0.04 to 0.08 wt % of an organic acid catalyst,
0.5 to 10 wt % of an inorganic component selected from the group consisting of: silica dioxide gel, pyrogenic silica, crystalline silica, titanium dioxide, nanographite, nanographene and water glass (WGSi), and
up to 100 wt % water, wherein weight percentages are percentages of the total weight of the composition.

4. The composition according to claim 1, comprising
5 to 13 wt % of a polymerized C₁₄₋₂₀alkanetrimethoxyalkoxysilane,
0.4 to 1.1 wt % of a surfactant,
0.05 to 0.30 wt % of an organic acid catalyst, and
up to 100 wt % water, wherein weight percentages are percentages of the total weight of the composition.

5. The composition according to claim 1, wherein the polymerized silane is polymerized C₁₄₋₂₀ alkanetrimethoxysilane.

6. The composition according to claim 1, wherein the polymerized silane is hexadecyltrimethoxysilane or octadecyltrimethoxysilane.

7. The composition according to claim 1 wherein the organic acid catalyst is selected from the group consisting of: tartaric acid, citric acid and oxalic acid.

8. The composition according to claim 1, wherein the organic acid catalyst is citric acid.

9. The composition according to claim 1, wherein the organic acid catalyst is selected from the group consisting of: comprising fumaric acid, maleic acid and lactic acid.

10. (canceled)

11. The composition according to claim 1, wherein the inorganic component is selected from the group consisting of: silica dioxide gel, pyrogenic silica, titanium dioxide, nanographite and water glass (WGSi).

12. The composition according to claim 1, wherein the inorganic component is selected from the group consisting of: silica dioxide gel and pyrogenic silica.

13. A process for the manufacturing of the composition according to claim 1 comprising the steps of
a) providing the solution of 0.5 to 1.5 wt % or 0.6 to 0.9 wt % of surfactant and 0.04 to 0.5 wt %, or 0.05 to 0.3 wt %, or 0.04 to 0.08 wt % of an organic acid catalyst,
b) adding 5 to 15 wt %, or 6 to 12.5 wt %, or 2 to 5 wt %, or 4 to 5 wt % of C₁₀₋₃₀alkanetriC₁₋₅alkoxysilane until polymerized and homogenized,
c) optionally, providing 0.5 to 10% wt or 1 to 5% wt solution of the inorganic component,
d) optionally adding the solution of the inorganic component to the polymerized C₁₀₋₃₀alkanetriC₁₋₅alkoxysilane, and
e) homogenizing the obtained mixture, wherein weight percentages are percentages of the total weight of the composition.

14. The process according to claim 13, wherein the polymerized silane is hexadecyltrimethoxysilane or octadecyltrimethoxysilane.

15. The process according to claim 13, wherein the organic acid catalyst is selected from the group consisting of: tartaric acid, citric acid, oxalic acid, fumaric acid, maleic acid and lactic acid.

16. A process for the manufacturing 0.5 to 10% wt suspension of water glass for use in the composition according to claim 1 comprising the steps of:
c1) mixing a 20 to 30 wt % solution of a sodium silicate solution with 0.045 to 0.07 wt % of an organic acid catalyst, which is citric acid at room temperature,
c2) adding water to obtain a 50 ml/10 g sodium silicat solution,
c3) adjusting pH to 6 to 6.5 using HCl,
c4) precipitating the silicate,
c5) washing off sodium chloride,
c6) diluting the obtained solution to obtain 10 wt % of the inorganic component, and
c7) homogenizing the obtained solution.

17. A method for transparently coating organic or inorganic surfaces comprising coating the organic or inorganic surface with a composition of claim 1.

18. A method for applying a water repellant coating-on organic or inorganic surfaces comprising coating the organic or inorganic surface with a composition of claim 1.

19. A method for applying a mold-resistant coating on organic or inorganic surfaces comprising coating the organic or inorganic surface with a composition of claim 1.

20. A method for applying a fire-resistant coating on organic or inorganic surfaces comprising coating the organic or inorganic surface with a composition of claim 1.

21. An organic or inorganic surface coated with the composition according to claim 1.

22. A method for performing a reaction between the composition according to claim 1 and a surface characterized in that heat pressing is used to apply the composition on the surface.

23. (canceled)
